(19) United States
(12) Patent Application Publication
(10) Pub. No.: US 2005/0067530 A1
(43) Pub. Date: Mar. 31, 2005

(54) Cabin services system for a mobile platform

(76) Inventors: Roland L. Schafer JR., Auburn, WA (US); Sudhakar S. Shetty, Mercer Island, WA (US); Philip S. Mattson, Bothell, WA (US); Delfin T. Silva, Kenmore, WA (US); Gerald Dean Lui-Kwan, Kent, WA (US)

Correspondence Address: HARNESS, DICKEY & PIERCE, P.L.C., P.O. BOX 828, BLOOMFIELD HILLS, MI, 48303, US

(21) Appl. No.: 10/670,952

(22) Filed: Sep. 25, 2003

(51) Int. Cl. B64D 11/00

(52) U.S. Cl. 244/118.5

(57) ABSTRACT

A cabin services system (CSS) architecture in a mobile platform includes the same type of bus for communicating with and controlling CSS subsystems. A controller controls operation of the CSS subsystems using programmable modules provided in connection with the CSS subsystems. This may include control of lighting and audio operations. Switches also may be provided for controlling transmission of data from the controller to the subsystems for controlling CSS subsystem operations. The CSS Architecture provides a flexible and fully scalable CSS which may be economically installed on many different mobile platforms.

### FIELD OF THE INVENTION

The present invention relates generally to cabin services systems for mobile platforms, especially for aircraft, and more specifically to an architecture for a cabin services system for aircraft.

### BACKGROUND OF THE INVENTION

A cabin services systems (CSS) typically includes a plurality of different subsystems, for example, audio communication, cabin lighting, information signs, and monitor and control subsystems. Known CSSs are usually designed for a unique implementation, such as for a specific aircraft, and can vary greatly based upon the system or operation requirements for a particular mobile platform. These known CSSs range from hard coded hardware line replaceable units (LRUs) and wired logic implementations to software loadable, multiple bus type architectures.

These known CSSs are not scalable to support mobile platforms (e.g., passenger aircraft) having different configurations and seating capacities. For example, these CSSs are not scalable for use with different aircraft ranging from one hundred to five hundred plus seats in a cost effective manner. Additionally, optimization of the subsystems has resulted in implementations with unique data bus types and protocols within the various CSSs. Multiple proprietary data bus implementations within the same mobile platform increase total weight of the system, as well as increasing costs (e.g., manufacture, Installation and maintenance costs). The unique implementations also result in increased costs when replacing obsolescent parts and adding new functionality.

These known CSSs also require extensive design time, for example, for each different aircraft design, and lack flexibility for future modification. Thus, custom installations are required that include multi bus implementations to control the various subsystems of the CSS.

### SUMMARY OF THE INVENTION

Various embodiments of the present invention provide a cabin services systems (CSS) in a mobile platform, and more particularly a CSS architecture that includes the same type of bus for communicating with and controlling subsystems of the CSS. A controller controls operation of the CSS subsystems preferably using programmable modules provided in connection with the CSS subsystems. This may include control of lighting and audio operations so that the system may control any device that supplies any visual or audio provided to the crew and passengers. Audio may include pilot announcements, attendant announcements, audio, music, and prerecorded audio. Lighting may include area lights, general cabin lighting, information signs (such as fasten seat belt, and no smoking signs) passenger call lights, and cabin interphone lights. Switches also may be provided for controlling transmission of data from the controller to the subsystems for controlling CSS subsystem operations.

Specifically, in one embodiment of the present invention, a cabin services system for use with mobile platform includes a plurality of subsystems providing one or more operations within the cabin and a controller for controlling the one or more operations of the plurality of subsystems. Further, one or more busses connecting each of the plurality of subsystems to the controller are provided, with the one or more busses being of the same type. A plurality of switches for controlling transmission of data between the plurality of subsystems via the one or more busses also may be provided. Additionally, one or more programmable modules (e.g., light or audio modules) associated with one or more of the plurality of subsystems is preferably provided, with the controller configured to control the one or more operations via the one or more busses using the programmable modules.

In another embodiment of the present invention, a mobile platform having a cabin services system for controlling lighting and audio operations within the cabin of the mobile platform includes a plurality of passenger seats, a plurality of lighting and audio components within the cabin, each of the plurality of lighting and audio components associated with one or more passenger seats, and a plurality of programmable modules (e.g., light or audio modules) associated with the plurality of lighting and audio components. A controller for controlling operation of the plurality of lighting and audio components using the plurality of modules is provided, with the plurality of modules connected to the controller via busses having the same bus type.

A method of the present invention for controlling operations within a cabin of a mobile platform includes selectively activating one or more programmable modules for controlling operations within the cabin, with the one or more programmable modules connected to a controller via one or more busses. The busses are of the same type. The method further may include determining control commands for controlling the programmable modules using a lookup table.

Further areas of applicability of the various embodiments of the present invention will become apparent from the detailed description provided hereinafter. It should be understood that the detailed description and specific examples are intended for purposes of illustration only and are not intended to limit the scope of the various embodiments of the invention.

### BRIEF DESCRIPTION OF THE DRAWINGS

The present invention will become more fully understood from the detailed description and the accompanying drawings, wherein:

FIG. 1 is a block diagram of one embodiment of a cabin services system architecture constructed according to the present invention.

### DETAILED DESCRIPTION OF THE PREFERRED EMBODIMENTS

The following description of the preferred embodiments is merely exemplary in nature and is in no way intended to limit the invention, its application, or uses. Although the various embodiments of the present invention are described in connection with particular systems having specific functionality for use in mobile platforms, they are not so limited, and the various embodiments may be provided in connection with different systems having different or additional functionality.

In general, various embodiments of the present invention provide a system architecture for a cabin services system (CSS) for a mobile platform (e.g., an aircraft) that includes the same type of bus for communicating with CSS subsystems. The architecture is scalable for use in different environments (e.g., different types of aircraft cabins) as desired or needed.

Various embodiments of a CSS constructed according to the principles of the present invention generally provide control of audio and light operations within a cabin of a mobile platform, such as within the cabin of a commercial aircraft. This includes, but is not limited to, control of cabin audio systems for use, for example in making announcements, control of crew intercommunication systems, and control of passenger and emergency lighting within the cabin of the mobile platform. It should be noted that the audio and lighting functionality may be provided in connection with each individual seat (e.g., headphone interface with each passenger seat or overhead lighting for each passenger seat) or for portions of the cabin (e.g., speaker for use in public announcements or emergency lighting signs). The CSS also communicates with other systems on-board a mobile platform for use in controlling the audio and light operations. For example, the CSS communicates with aircraft systems (e.g., air to ground systems) and in-flight entertainment systems (e.g., passenger video displays).

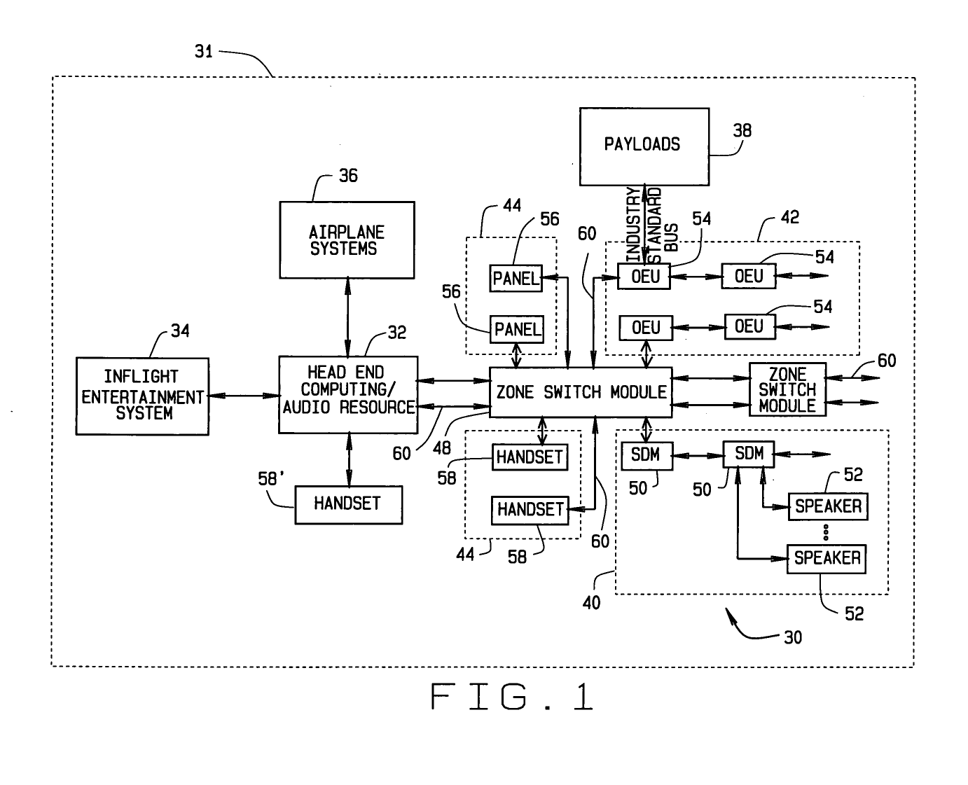

Specifically, one exemplary embodiment of a CSS architecture of the present invention is shown is FIG. 1 and indicated generally by reference numeral 30. The CSS 30 is disposed on an aircraft 31 and includes a controller 32 (e.g., head end computing and audio resource controller) communicating and/or providing an interface to control subsystems within the CSS 30. These subsystems include, but are not limited to, an in-flight entertainment subsystem 34, an aircraft subsystem 36, payloads 38 (e.g., lavatories, galleys, closets, etc.), audio subsystems 40, lighting subsystems 42 and crew interface subsystems 44. With respect to the audio subsystems 40, lighting subsystems 42 and crew interface subsystems 44, the controller 32 is preferably connected thereto via a zone switch module 48 (e.g., Ethernet switch or router), which provides data flow control between these subsystems.

In one exemplary embodiment, the audio subsystems 40 include one or more programmable modules (e.g., speaker drive modules 50) for use in controlling audio operations with the cabin, such as speakers 52 for making public announcements to passengers within the cabin.

The lighting subsystems 42 include one or more programmable modules (e.g., overhead electronic units 54) for use in controlling lighting operations within the cabin. This may include, for example, control of passenger and/or emergency lighting.

The crew interface subsystems 44 may include one or more interface panels 56 for use in selecting and operating various audio and lighting functions within the cabin. The crew interface subsystems 44 may also include one or more handsets 58 for use, for example, in making public announcements within the cabin or for communication between crew members at different locations within the cabin.

It should be noted that the number and location of the audio subsystems 40, lighting subsystems 42 and crew interface subsystems 44, and the components associated therewith may be modified as desired or needed for the particular mobile platform. For example, the interface panels 56 may be provided at different locations within a cabin of an aircraft depending upon the size and configuration (e.g., seating arrangement) of the aircraft cabin. Further, one or more zone switch modules 48 may be provided as part of the CSS 30 as desired or needed. It should also be noted that the zone switch modules 48 may be connected in a daisy chain or series arrangement as shown in FIG. 1, or alternately, in a star or hub type arrangement depending upon, for example, system requirements.

Further, and referring again to FIG. 1, in one exemplary embodiment busses 60 interconnecting the various components within the CSS 30 may be four wire busses using IEEE 10/100 Base T Ethernet or other local area network (LAN) cable. The backbone of the CSS 30 from the controller 32 to the zone switch module 48, and from zone switch module 48 to zone switch module 48, may use two unique switched Ethernet busses, one for passenger address (PA) audio plus cabin data network and the other for cabin interphone (CI) network. The two networks are connected inside each zone switch module 48 to connect a handset 58 to the PA bus while the handset 58 is in PA mode, thereby allowing each wired handset 58 access to the PA audio bus, for example, when making public announcements within the cabin. While in a CI mode, the handset 58 is connected to the CI bus for use in communicating between handsets 58, for example, used by cabin crew communicating with each from different locations within the cabin.

The busses 60 between the handset 58 and the zone switch modules 48 may also be four wire busses using IEEE 10/100 Base T Ethernet or other four wire LAN cable with the handset being Voice over Internet Protocol (VoIP) ready to set up calls and initiate multicast sessions with a public announcement (PA) system within the cabin. It should be noted that the handset 58 receives power from the zone switch modules 48 and the power is passed over the busses 60 (e.g., Ethernet wires) without the need for additional power wires. Further, it should be noted that the handset 58′ in the flight deck, for example, for use by a pilot, operates in the same manner for PA announcements, except the handset 58′ may be connected directly to the controller 32.

In operation, the routing of the VoIP signal is switched from the CI LAN to the PA LAN at the zone switch module 48 and provided directly to the speaker drive modules 50 without passing through the controller 32. Thus, every handset 58 has direct access to the speakers 52 (e.g., PA speakers). Further, the zone switch module 48 routes the handset VoIP to a CI partition in the controller 32 to process calls. Specifically, a call manager for a cabin interphone system (CIS) resides in the controller 32 in the CI partition and provides the VoIP conference call functionality. In general, the call manager provides an operator function which includes directing, or routing, communication between the handsets. For communications between 3 or more handsets, the call manager sets up the communications between the handsets involved.

The CI partition is unique from commercial off the shelf applications, and the CIS operates, for example, with remote chimes, call lights, and minimum functionality for an “all call” for all installed handsets 58. The call lights and chimes replace the ringing function of the telephone. In case the attendants are away from the attendant stations when an incoming call arrives at their handset(s), the cabin interphone uses the call lights and chimes through the cabin speakers to alert the attendants to the incoming calls.

The zone switch module 48 also routes lighting data and panel 56 data to the controller 32 for use in controlling lighting operation within the cabin. Processing requirements for the zone switch module 48 may be provided in data tables to determine their enabled functions as described herein.

The speaker drive modules 50 include a resident priority manager for use in operating the speakers 52, for example when making cabin announcements of different priorities. For instance, the priority manager prioritizes announcements from the flight deck as having the highest priority. Then in descending order, the priority manager prioritizes announcements from the attendants, recorded announcements, announcements, and boarding music. Accordingly, the priority manager overrides lower priority announcements with higher priority announcements.

The speaker drive module 50 is preferably multicast enabled to provide the PA audio. Each speaker 52 is also preferably enabled to produce audio for a predetermined number of PA areas within the cabin (e.g., at least 8 PA areas having a set of passenger seats associated therewith) and defined in a speaker drive module data table. These data tables include a look up table which the priority manager uses to compare incoming announcements with the types of announcements which the particular speaker 52 is pre-selected to announce. Accordingly, the speakers 52 provided by the present invention provide announcements based on these pre-selections (e.g. programming).

The overhead electronics units 54 preferably drive light emitting diodes (LEDs) or other light sources (e.g., halogen lamps) for providing lighting within the cabin. For example, a digital interface to ballast/mood lighting is provided. Herein, the lighting sources are assumed to be smart (as are the devices within the other subsystems), or commandable, via a digital interface or bus. Thus, the present invention provides control of these light sources through the bus without point to point wiring between the overhead electronic units and the lighting sources.

Configuration data is used by modules (e.g. SDM or OEU) of the CSS 30 to provide the functionality required of the CSS 30. The configuration data for CSS 30 may be defined by an external database tool that defines the physical usage of each input and output port and the logical affect that each input has on the system. The external tool can map any combination of input(s) to any combination of output(s) in CSS. The external tool maps the CSS inputs via logical expressions or mathematical combinations of state(s) to apply the appropriate transaction for the required output(s) that define the functionality of the system and ultimately each port. The configuration data expressions may be provided to each module by Ethernet IP based communications that are carried by the same bus or LAN 60 that carries the digital audio for audio system.

Thus for each audio or lighting module may have an associated function or expression in the CSS 30 which controls the module. For instance, programmable signs may be programmed to display a given sign such as a “Fasten Seat Belt” sign. Moreover, the “Fasten Seat Belt” sign may be defined as having two modes, off and on. An exemplary logical expression for determining the state of the sign may be defined as:
Fasten Seat Belt Sign Mode=(Fasten Seat Belt Switch=ON) OR ((Fasten Seat Belt Switch=Auto) AND (Landing Gear extended OR Cabin Pressure>(Data Table Value) OR Aircraft Altitude<{Data Table Value})) OR (Fasten Seat Belt Switch=OFF).

Where the operands in the parenthesis ( ) represent mobile platform state information that may be digital data received by the CSS 30 from the other mobile platform systems 36. In contrast, the operands in the brackets { } may be data entries which were previously defined with the external database tool for each of the functions.

Thus, the logical expression “Fasten Seat Belt Sign Mode” function shown above is an output of the CSS 30 and is used to control the “Fasten Seat Belt” sign. Moreover, the expression or function may reside in the data table of the head end unit 32. Accordingly, the head end unit 32 periodically or asynchronously calculates its outputs, which in this example includes the “Fasten Seat Belt Sign Mode” function. Depending on where the components associated with the function resides, the head end unit 32 may then transmit the result to the controlled components over one or more of the data buses 60.

Data tables also reside in each of the modules controlled by the CSS 30. The module data tables contain one or more fields which correspond to the outputs of the head end unit 32. Of course, each of the module data table fields may be labeled in a manner corresponding to the output which it is pre-selected to receive from the head end unit 32. The module uses the field in its data table to define the action which the module will take when the output (e.g. the “Fasten Seat Belt Sign Mode” function) changes state.

Continuing with the present example, when the Pilot changes the position of the “Fasten Seat Belt” switch, the head end unit 32 receives the new switch position from the other systems 36 and calculates the “Fasten Seat Belt Sign Mode” function. The head end unit 32 then transmits the new state to all of the components in communication with the CSS 30.

Like the “Fasten Seat Belt” Signs, the SDMs 50 may also have a data table entry that maps the “Fasten Seat Belt Sign Mode” function to pre-selected speakers 52 within the cabin. When the function changes state, the SDMs 50 respond with outputs to drive the pre-selected speakers 52, for instance, with chime sounds. Thus, the CSS 30 may audibly alert the crew and passengers to the change of state of the “Fasten Seat Belt” signs automatically.

Generally, each of the modules controlled by the CSS 30 receives head end unit 32 output functions over the data buses 60. Individual modules then respond to changes in the head end unit 32 outputs as the module is programmed to respond. Thus, for example, the “Fasten Seat Belt” signs may turn on or off in accordance with the change in state discussed above, and the SDMs 50 may drive the speakers 52 with a chime.

Turning now to another preferred embodiment, a CSS 30 is provided that includes the following:
(1) A wired backbone consisting of IEEE 10/100 Base T Ethernet or other LAN between the controller 32 and zone switch modules 48 selectively distributed throughout the cabin to optimize wiring;
(2) Standard IP based protocol with VoIP used for all audio;
(3) Dedicated switched Ethernet busses 60 between zone switch modules 48 and each distributed overhead electronics unit 54, speaker drive module 50 and panel 56;
(4) VoIP enabled handsets 58 connected in a daisy chain or star configuration to the zone switch modules 48;
(5) Audio announcements originating from the flight deck (e.g., using the flight deck handset 58′) and cabin handsets 58 provided by multicasting audio stream to speakers 52 and the in-flight entertainment system 34 using the same bus 60 as cabin lighting, and monitor and control for other subsystems;
(6) Handset 58 to handset 58 communications using a dedicated bus and VoIP to provide all cabin station to station calls, conference calls, or all handset calls with a single dial code entry; and
(7) Cabin panels 56 configured as web browsers that can control cabin lighting, and monitor and control other cabin features.

Thus, various embodiments of the present invention provide a CSS 30 that is scalable, for example, for use in aircraft of different sizes, and that is more cost and weight effective. The CSS 30 achieves single system architecture (i.e., all busses 60 being of the same type) for the backbone of all CSS 30 subsystems. This minimize data bus types and reduces the cost of, for example, subsystem auto test features and improves software load capabilities. The CSS 30 eliminates the need for proprietary protocols and leverages current audio and data technologies. The CSS 30 provides functionality upgrade capability through the use of data tables and leverages the throughput capability of a standard IP based bus architecture. The CSS 30 enables conference calling capability for a plurality of users (e.g., more than twenty five callers) using VOIP.

It will be appreciated that while the present invention has been described in connection with an aircraft, that the invention could just as readily be used on virtually any form of mobile platform such as a bus, ship, train, etc. Accordingly, the invention should not be interpreted as being limited to an aircraft

While various preferred embodiments have been described, those skilled in the art will recognize modifications or variations which might be made without departing from the inventive concept. The examples illustrate the invention and are not intended to limit it. Therefore, the description and claims should be interpreted liberally with only such limitation as is necessary in view of the pertinent prior art.

1. A cabin services system for use with mobile platforms, the cabin services system comprising:
a plurality of subsystems providing one or more operations within a cabin of a mobile platform;
a controller for controlling the one or more operations of the plurality of subsystems; and
one or more busses connecting each of the plurality of subsystems to the controller, the one or more busses being of the same type.

2. The cabin services system according to claim 1, further comprising:
a plurality of switches for controlling transmission of data between the plurality of subsystems and the controller via the one or more busses.

3. The cabin services system according to claim 2, wherein the plurality of switches are configured in one of a series and star configuration.

4. The cabin services system according to claim 1, further comprising:
one or more programmable modules associated with one or more of the plurality of subsystems, with the controller configured to control the one or more operations via the one or more busses using the programmable modules.

5. The cabin services system according to claim 4, wherein the one or more programmable modules comprise at least one of (i) light modules for controlling lighting operations within the cabin, (ii) signs modules for controlling signs within the cabin, and (iii) audio modules for controlling audio operations within the cabin.

6. The cabin services system according to claim 1, further comprising:
one or more crew interfaces connected to one or more of the plurality of subsystems via the one or more busses.

7. The cabin services system according to claim 1, wherein the plurality of subsystems comprise at least one of an audio subsystem, a lighting subsystem, and a crew interface subsystem.

8. The cabin services system according to claim 1, wherein the controller comprises one or more lookup tables having control information therein for use in controlling the plurality of subsystems.

9. The cabin services system according to claim 8, wherein the one or more lookup tables comprise control commands associated with one or more states of the plurality of subsystems.

10. A mobile platform having a cabin services system for controlling lighting and audio operations within a cabin of the mobile platform, the mobile platform comprising:
a plurality of passenger seats;
a plurality of lighting and audio components within the cabin, each of the plurality of lighting and audio components associated with one or more of the plurality of passenger seats;
a plurality of programmable modules associated with the plurality of lighting and audio components; and
a controller for controlling operation of the plurality of lighting and audio components using the plurality of modules, the plurality of modules connected to the controller via busses having the same bus type.

11. The mobile platform according to claim 10, wherein the plurality of programmable modules comprise at least one of (i) light modules for controlling the lighting components and (ii) audio modules for controlling audio components.

12. The mobile platform according to claim 10, further comprising:
crew interfaces for operating the lighting and audio components.

13. The mobile platform according to claim 12, wherein the crew interfaces comprise at least one of audio handsets and panel displays.

14. The mobile platform according to claim 10, wherein the programmable modules comprise programmable switches.

15. The mobile platform according to claim 10, wherein the busses comprise LAN busses.

16. The mobile platform according to claim 10, wherein the lighting components comprise at least one of passenger cabin lighting and emergency cabin lighting.

17. The mobile platform according to claim 10, wherein the audio components comprise at least one of handsets and cabin speakers.

18. A method of controlling operations within a cabin of a mobile platform, the method comprising:
connecting one or more programmable modules to one or more busses, the one or more busses being of the same type;
receiving information from at least one of the mobile platform, the crew of the mobile platform, and the passengers on the mobile platform; and
selectively activating one or more programmable modules for controlling operations within the cabin in response to the information.

19. The method according to claim 18, further comprising:
determining control commands for controlling the programmable modules using a lookup table.

20. The method according to claim 18, wherein the programmable modules are configured to control operation of at least one of cabin lighting and cabin audio operations.
